(19) United States
(12) Patent Application Publication
(10) Pub. No.: US 2009/0289463 A1
(43) Pub. Date: Nov. 26, 2009

(54) POSITIONING MEMBER FOR PREVENTING DETACHMENT OF AXLE

(76) Inventor: FAN-CHANG TSAI, Taipei (TW)

Correspondence Address: LEONG C LEI, PMB # 1008, 1867 YGNACIO VALLEY ROAD, WALNUT CREEK, CA, 94598, US

(21) Appl. No.: 12/406,128

(22) Filed: Mar. 18, 2009

(30) Foreign Application Priority Data
May 21, 2008 (TW) 097208870

(51) Int. Cl. E05B 15/02

(52) U.S. Cl. 292/341.15

(57) ABSTRACT

A positioning member is coupled to a mounting plate, which defines a plurality of holes for receiving screws for connection with an end of an external object. An upper adjustment nut sets a distance between a roller seat and the mounting plate and to provide a securing function by cooperating with a roller seat nut and a roller seat bolt. The mounting plate forms in a central portion thereof an elongate slot for slidably receiving a neck of the axle therein. The positioning member includes a plate-like body forming a straight slot and an inclined slot for leading the neck therein and is provided with a rivet or a resilient fork-like fastener at one side of the inclined slot opposite to the straight slot to be fit into the a positioning hole defined beside the elongate slot for serving as a rotational axis of the positioning member.

### TECHNICAL FIELD OF THE INVENTION

The present invention generally relates to a positioning member that prevents an axle of a roller-based suspension device from separation from a suspended object.

### DESCRIPTION OF THE PRIOR ART

Various foldable doors or windows are available in the market. Some are used to isolate an area inside a house by providing a rail on a ceiling corresponding to the area to be isolated. The foldable door is provided with plural sets of roller based suspension devices, such as a slide door roller set or a suspension roller set. In this way, an area inside a house can be quickly isolated as desired to suit the needs for various applications and also to reduce the undesired external interference, as well as serving as means for privacy protection. After the use of the isolated area, the foldable door or a plurality of door panels can be moved to a corner to stack each other or to be removed, by which the original indoor space of the house resumes.

### SUMMARY OF THE INVENTION

The known slide roller set is threadingly coupled to a lower suspension member and is received in mounting seat provided at a top edge of a door panel for positioning. The lower suspension member is of a large size and has to be positioned through the mounting seat. It is generally not easy to efficiently separate from the mounting seat at the time of dismounting and such an operation requires loosening of an adjustment bolt in order to replace the lower suspension member. Thus, efficient mounting and dismounting is generally impossible and it is often that a thin nut gets lost due to carelessness and negligence.

As to the known suspension roller set, it uses a positioning plate and a connection plate to mount an adjustment bolt below a roller seat by means of screws. The adjustment bolt is coupled to a fixing board at a door top in a threaded manner. Consequently, to dismount, the roller seat must be removed from a top rail and then the adjustment bolt is loosened to separate from the fixing board, or tools must be employed to dismount the connection plate in order to separate the roller seat and the adjustment bolt. This makes it impossible to efficiently mount and dismount the suspension roller set and a number of parts are needed, which increase the manufacturing costs and the manufacturing time.

In view of the above problems, an objective of the present invention is to provide a positioning member that realizes easy application of force to rotate, reduction of frictional area during the rotation, efficient mounting and dismounting, and prevention of detachment of an axle.

To solve the above problems and to realize the objective of the present invention, the present invention provides a positioning member that prevents detachment of an axle, wherein the positioning member is coupled to a mounting plate, which defines a plurality of holes for receiving screws for connection with an end of an external object. An upper adjustment nut sets a distance between a roller seat and the mounting plate and to provide a securing function by cooperating with a roller seat nut and a roller seat bolt. The mounting plate forms in a central portion thereof an elongate slot for slidably receiving a neck of the axle therein. A projection is formed beside the elongate slot to support a lower adjustment nut. The positioning member includes a plate-like body forming a straight slot and an inclined slot for leading the neck therein and is provided with a rivet or a resilient fork-like fastener at one side of the inclined slot opposite to the straight slot to be fit into the a positioning hole defined beside the elongate slot for serving as a rotational axis of the positioning member.

In accordance with the above described positioning member for preventing detachment of an axle, the positioning member forms a bent tab that extends downward from an edge of the plate-like body at a location adjacent to the straight slot.

In accordance with the above described positioning member for preventing detachment of an axle, sides of the straight slot form shaped sections, of which one shaped section forms a stop that is receivable into the elongate slot to prevent undesired separation.

In accordance with the above described positioning member for preventing detachment of an axle, another side of the straight slot forms a second stop corresponding to the above described stop.

As compared to the known techniques, the positioning member for preventing detachment of axle in accordance with the present invention is different from the known techniques in that it offers the following advantages:

(1) The positioning member of the present invention uses a straight slot to reduce the contact friction with respect to the mounting plate to allow fast rotation of the positioning member for locking and/or releasing the axle. And when the positioning member is subjected to heating and thus expands or is acted upon by an external force to undergo twisting and deformation, the straight slot provides spacing for adjustment between the shaped sections on opposite sides thereof, whereby jamming and being difficult to rotate due to thermal expansion or deformation of the shaped sections can be eliminated.
(2) The positioning member of the present invention uses a rivet or a resilient fork-like fastener that is fit into a positioning hole to serve as a rotational axis of the positioning member, and also uses an end of the rivet or barbs formed at ends of the resilient fork-like fastener to prevent undesired separation of the positioning member and the mounting plate.
(3) A stop is provided on the above described shaped section to make the positioning member difficult to be moved by an external force. The shaped section located at an outer side of the straight slot provides an end that allows a user to apply a force thereto for rotating the positioning member and can be cooperate with a bent tab to allow the user to simultaneously apply forces thereto in order to allow the user to change the direction of force application during the rotation of the positioning member.
(4) When a lower adjustment nut is tightened to the positioning member, the mounting plate is provided with a spot projection beside the elongate slot at a location corresponding to the inclined slot for supporting the lower adjustment nut, providing a uniform force application area and balancing the inclined external force.
(5) When the object is provided with more than two roller seats, to ensure consistent spacing between each roller seat and the object, an upper adjustment nut is used to set the distance between the roller seat and the mounting plate and to provide a securing function by cooperating with a roller seat nut and a roller seat bolt.

The foregoing objective and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view of the present invention.

FIG. 2 is an exploded view of the present invention.

FIG. 3 is an enlarged view of a positioning member in accordance with the present invention.

FIGS. 4 and 5 are cross-sectional views taken along line X-X of FIG. 1, illustrating the operation of the present invention.

FIG. 6 is a perspective view of a positioning member in accordance with another embodiment of the present invention.

FIG. 7 is a perspective view showing a positioning member in accordance with an embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

The present invention will now be explained with reference to the drawings.

### First Embodiment

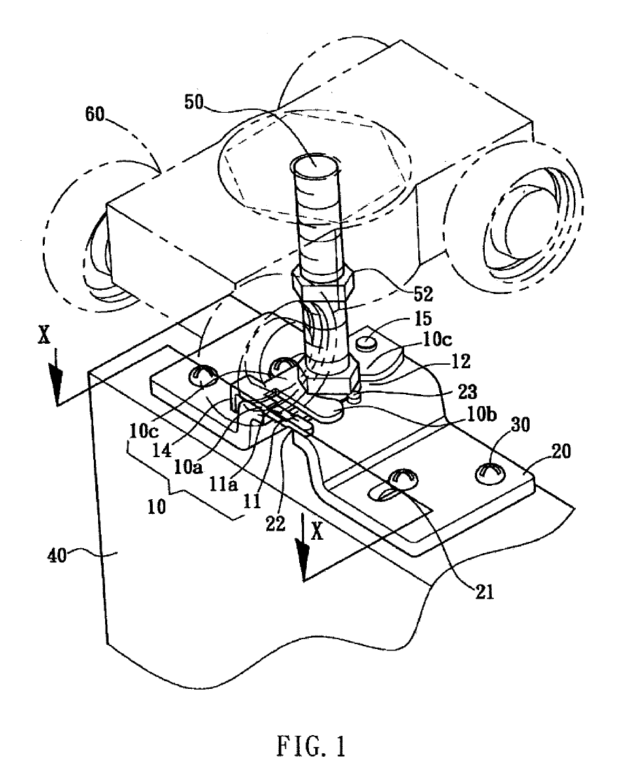

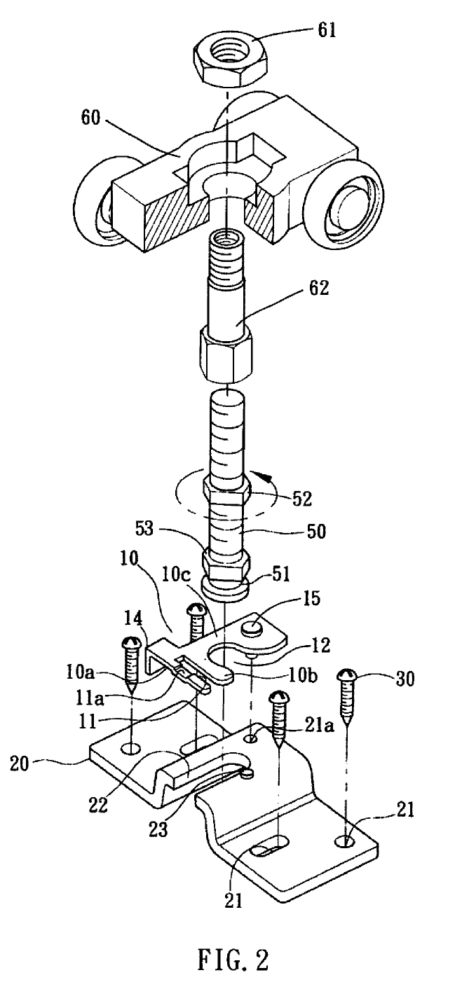

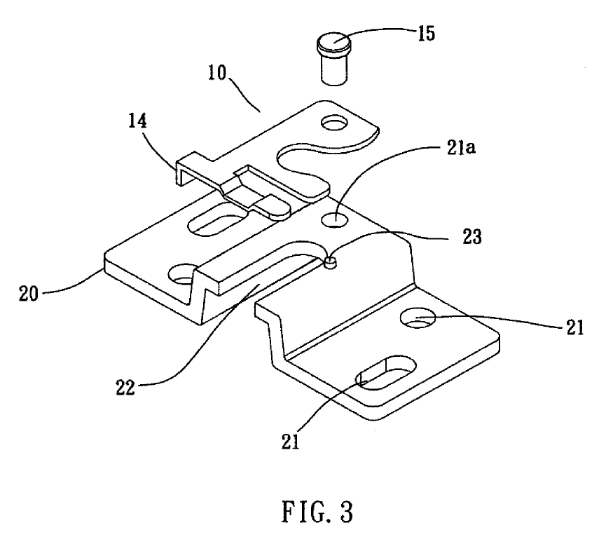

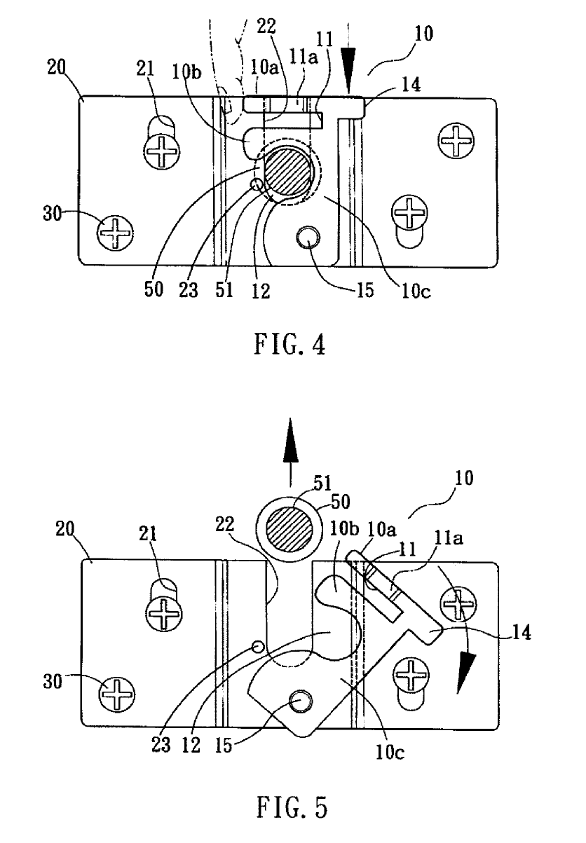

FIG. 1 shows a perspective view of a first embodiment in accordance with the present invention. FIG. 2 shows an exploded view of a positioning member in accordance with the present invention. FIG. 3 shows an enlarged view of a resilient fork-like fastener shown in FIG. 2. FIGS. 4 and 5 are cross-sectional views taken along line X-X of FIG. 1, illustrating the operation of the positioning member as viewed from the top side.

The above mentioned drawings show that the positioning member 10 provided in accordance with the present invention for preventing the detachment of an axle is coupled to a mounting plate 20. The mounting plate form a plurality of holes 21 that extends through the mounting plate for receiving the extension of threaded fasteners 30 to couple to an end face of an object 40. An upper adjustment nut 52 functions to adjust the distance between a roller seat 60 and the mounting plate 20 and to cooperate with a roller seat nut 61 and a roller seat bolt 62 to effect securing. The mounting plate forms in a central portion thereof an elongate slot 22, preferably having an open end, for movably receiving a neck 51 of an axle 50 therein. The object 40 mentioned above can be for example a foldable door, a door panel, or a window panel. The holes 21 include elongated holes for adjustment purposes and circular holes. The axle 50 is threadingly coupled to a central portion of the roller seat 60 and the axle 50 is provided with the upper adjustment nut 52 and a lower adjustment nut 53 that adjust the length for threading coupling. However, it is noted that the above mentioned components/parts, such as the axle 50 and the roller seat 60, are identical to or similar to the conventional counterparts.

The feature of the present invention is that the positioning member 10 comprises a plate-like body that forms a straight slot 11 and an inclined slot 12 for receiving the neck 51. The plate-like body is also provided with a rivet 15 or alternatively a resilient fork-like fastener 13 at the side of the inclined slot 12 that is opposite to the slot 11 to be fit into the a positioning hole 21a defined beside the elongate slot 22 for serving as a rotational axis of the positioning member 10.

The straight slot 11 and the inclined slot 12 divide the slotted-side portion of the positioning member 10 into three limb-like shaped sections 10a, 10b, 10c, whereby the positioning member 10 is formed as an E-shaped or an F-shaped plate. The inclined slot 12 is curved and forms a diverging opening, whereby one of the shaped sections (namely shaped section 10c) that delimit the inclined slot 12 has an expanded root portion so as to effectively lead and the neck 51 of the axle 50 into the inclined slot 12 for retention at the time when the positioning member 10 is rotated. Apparently, by reducing the expanded root portion of the shaped section 10c, the inclined slot 12 may accommodate a larger side of the neck 51 of the axle 50.

As shown in FIG. 2, the roller seat 60 forms a through hole at the central portion thereof to receive and retain therein the roller seat nut 61 and the roller seat bolt 62. When the object 40 is provided with more than two roller seats 60, to ensure consistent spacing between each roller seat 60 and the object 40, the vertical location of each roller seat 60 must be properly adjusted. The present invention utilizes the above described upper adjustment nut 52 to set the distance between the roller seat 60 and the mounting plate 20. After completion of the distance adjustment, since the contact surface between the roller seat bolt 62 and the central hole of the roller seat 60 has no threading, rotation of the roller seat nut 61 can set the roller seat nut 61 to the position of the upper adjustment nut 52, but the orientation of the roller seat 60 is not affected or changed by the rotation operation, whereby efficient and effective adjustment of the distance between each roller seat 60 and the object 40 can be realized.

The positioning member 10 of the present invention uses the straight slot 11 formed therein to reduce the frictional force between the positioning member 10 and the mounting plate 20, making it possible to fast rotate the positioning member to effect locking/releasing of the axle 50. In addition, when the positioning member is subjected to heating and undergoes expansion or twisting and deformation, the straight slot provides spacing for adjustment between the two shaped sections 10a, 10b on the opposite sides of the straight slot, whereby jamming and being difficult to rotate due to thermal expansion or deformation of the shaped sections 10a, 10b can be eliminated. One of the shaped sections, namely the shaped section 10a, is provided with a stop 11a that is receivable into the elongate slot to prevent undesired separation. The stop makes the shaped section showing a step-like configuration, so that the positioning member 10 is not susceptible to get loosened due to external impact. Further, when the lower adjustment nut 53 is tightened on the positioning member 10, a gap is present between the lower adjustment nut 53 and the mounting plate 20 at the location corresponding to the inclined slot 12. When the structure is subjected to a non-uniform external force acting thereon, the lower adjustment nut 53 is prone to incline toward the gap in the inclined slot 12, causing the force to concentrate at such an inclination location. To solve the problem, the present invention provides a spot projection 23 on the mounting plate 20 at a location corresponding to the inclined slot 12 to support the lower adjustment nut 53 and balance the distribution of the external force.

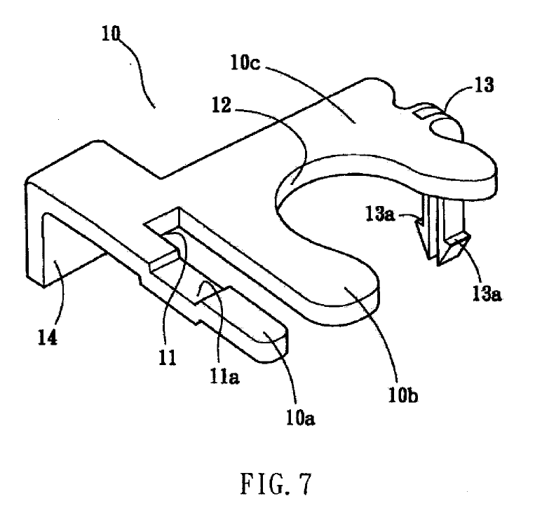

Further, the positioning member 10 uses the rivet 15 or the resilient fork-like fastener 13 shown in FIG. 7 that is fit into the positioning hole 21a to serve as the rotational axis of the positioning member 10, and also uses an end of the rivet 15 or barbs 13a formed at ends of the resilient fork-like fastener 13 to prevent undesired separation of the positioning member 10 and the mounting plate 20.

The positioning member 10 may be further provided with a bent tab 14 that extends downward at an edge of the plate-like body adjacent to the straight slot 11 to assist a user to apply a force for rotating the positioning member 10. As shown in FIG. 4, the user may also apply a force to the end of the shaped section 10a that is located at the outer side of the straight slot 11 to rotate the positioning member to allow removal of the axle 50 as shown in FIG. 5. The end of the shaped section 10a and the bent tab 14 both function to receive the force applied by the user in order to allow the user to change the direction of force application during the rotation of the positioning member 10.

### Second Embodiment

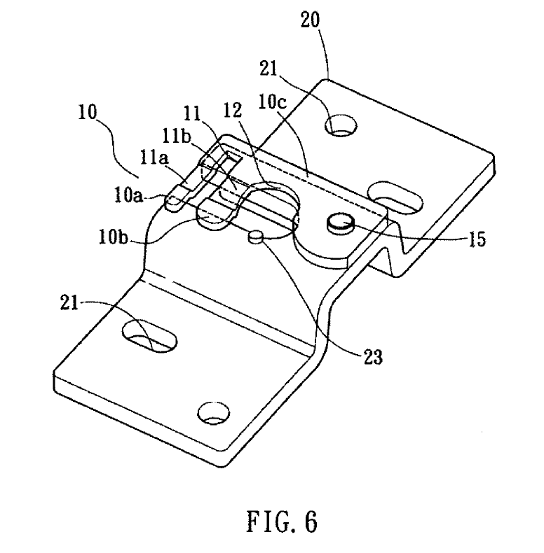

FIG. 6 shows a perspective view of a second embodiment of the positioning member in accordance with the present invention. The difference from the first embodiment is that the two shaped sections 10a, 10b on the opposite sides of the straight slot 11 are both provided with a stop 11a, 11b that is receivable into the elongate slot 22 to prevent undesired separation. Both stops make the respective shaped section showing a step-like configuration or they can be made corrugated (not shown). With the dual action of stopping by the two stops, the chance that the positioning member 10 gets loosened due to external impact is reduced. Further, in the second embodiment, the bent tab 14 is removed, whereby only shaped section 10a that is located at the outer side of the straight slot 11 can receive the force applied by the user to rotate the positioning member 10.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A positioning member for preventing detachment of an axle, being coupled to a mounting plate, which defines a plurality of holes for receiving screws for connection with an end of an external object, the axle being provided with an upper adjustment nut and a lower adjustment nut set, a roller seat being provided with a roller seat nut and a roller seat bolt, the mounting plate forming at a central portion thereof an elongate slot for slidably receiving a neck of the axle therein, characterized in that:
the positioning member comprises a plate-like body forming a straight slot and an inclined slot for leading the neck therein, the positioning member being provided with a rivet at one side of the inclined slot opposite to the straight slot to be fit into the a positioning hole defined beside the elongate slot for serving as a rotational axis of the positioning member.

2. The positioning member according to claim 1, wherein the positioning member forms a bent tab on an opposite edge of the plate-like body at a location adjacent to the straight slot, the bent tab extending vertically downward.

3. The positioning member according to claim 1, wherein two shaped sections are formed on opposite sides of the straight slot, of which one shaped section forms a stop that is receivable into the elongate slot to prevent undesired separation.

4. The positioning member according to claim 3, wherein the stop of the shaped section corresponds to the elongate slot.

5. The positioning member according to claim 1, wherein the rivet provided on one side of the inclined slot is replaced by a resilient fork-like fastener.

6. The positioning member according to claim 1, wherein the inclined slot is curved and forms a diverging opening.

7. The positioning member according to claim 1, wherein the mounting plate forms a project beside the elongate slot at a location corresponding to the inclined slot for supporting the lower adjustment nut.

8. The positioning member according to claim 1, wherein the upper adjustment nut functions to set a distance between the roller seat and the mounting plate and to provide a securing function by cooperating with the roller seat nut and the roller seat bolt.
